(19) United States
(12) Patent Application Publication
(10) Pub. No.: US 2009/0009431 A1
(43) Pub. Date: Jan. 8, 2009

(54) PLASMA DISPLAY PANEL AND PLASMA DISPLAY APPARATUS

(76) Inventors: Seongnam RYU, Gumi-City (KR); Gibum LEE, Gumi-City (KR); Jongmun YANG, Gumi-City (KR); Jain GOO, Gumi-City (KR); Hyeonjae LEE, Gumi-City (KR); Jinyoung KIM, Gumi-City (KR); Jeonghyun HAHM, Gumi-City (KR); Myongsoon JUNG, Gumi-City (KR); Jihoon LEE, Gumi-City (KR)

Correspondence Address: KED & ASSOCIATES, LLP, P.O. Box 221200, Chantilly, VA, 20153-1200, US

(21) Appl. No.: 11/931,200

(22) Filed: Oct. 31, 2007

(30) Foreign Application Priority Data
Jul. 5, 2007 (KR) 10-2007-0067437
Jul. 13, 2007 (KR) 10-2007-0070512

(51) Int. Cl. G09G 3/28

(52) U.S. Cl. 345/60

(57) ABSTRACT

A plasma display panel and a plasma display apparatus are disclosed. The plasma display panel includes a front substrate on which a scan electrode and a sustain electrode are positioned parallel to each other, an upper dielectric layer positioned on the scan and sustain electrodes, a rear substrate on which an address electrode is positioned to intersect the scan and sustain electrodes, a lower dielectric layer positioned on the address electrode, a barrier rib that is positioned between the front substrate and the rear substrate and partitions a discharge cell, and a phosphor layer that is positioned inside the discharge cell and includes YVPO₄:Eu. The scan electrode and the sustain electrode each having a single-layered structure.

This application claims the benefit of Korean Patent Application Nos. 10-2007-0067437 and 10-2007-0070512 filed on Jul. 5, 2007 and Jul. 13, 2007 which are hereby incorporated by reference.

### BACKGROUND OF THE DISCLOSURE

1. Field of the Disclosure

This document relates to a plasma display panel and a plasma display apparatus.

2. Description of the Related Art

A plasma display apparatus includes a plasma display panel.

The plasma display panel includes a phosphor layer inside discharge cells partitioned by barrier ribs and a plurality of electrodes.

A driving signal is supplied to the electrodes, thereby generating a discharge inside the discharge cells. When the driving signal generates a discharge inside the discharge cells, a discharge gas filled inside the discharge cells generates vacuum ultraviolet rays, which thereby cause phosphors formed inside the discharge cells to emit light, thus displaying an image on the screen of the plasma display panel.

### SUMMARY OF THE DISCLOSURE

In one aspect, In another aspect, In still another aspect,

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIG. 1 illustrates a structure of a plasma display panel according to an exemplary embodiment;

FIG. 2 illustrates an operation of the plasma display panel according to the exemplary embodiment;

FIGS. 3A and 3B illustrate a scan electrode and a sustain electrode each having a single-layered structure;

FIG. 4 illustrates a structure of a scan electrode and a sustain electrode;

FIGS. 5A and 5B illustrate a configuration of a scan electrode and a sustain electrode;

FIG. 6 illustrates a relationship between a single-layered electrode structure and a color representability;

FIG. 7 is a table showing of a composition of a phosphor layer;

FIG. 8 is a graph showing color coordinates of the plasma display panel according to the exemplary embodiment;

FIG. 9 is a table showing another implementation of a composition of a phosphor layer;

FIGS. 10A and 10B are graphs showing reflectances depending on a composition of each of first and second phosphor layers, respectively;

FIGS. 11A and 11B are graphs showing a reflectance and a luminance of the plasma display panel depending on changes in a content of red pigment, respectively;

FIGS. 12A and 12B are graphs showing a reflectance and a luminance of a plasma display panel depending on changes in a content of blue pigment, respectively;

FIG. 13 illustrates a composition of an upper dielectric layer;

FIG. 14 is a graph showing color coordinates of the plasma display panel according to the exemplary embodiment;

FIGS. 15A and 15B are a table and a graph showing characteristics of the plasma display panel depending on a content of pigment;

FIG. 16 is a diagram for explaining a Pb content of an upper dielectric layer;

FIG. 17 illustrates another structure of an upper dielectric layer;

FIG. 18 illustrates another structure of an upper dielectric layer;

FIGS. 19A and 19B illustrate another structure of the plasma display panel according to the exemplary embodiment;

FIG. 20 is a diagram for explaining the overlap of sustain signals; and

FIG. 21 is a diagram for explaining a first maintenance period and a second maintenance period.

### DETAILED DESCRIPTION OF EMBODIMENTS

Reference will now be made in detail embodiments of the invention examples of which are illustrated in the accompanying drawings.

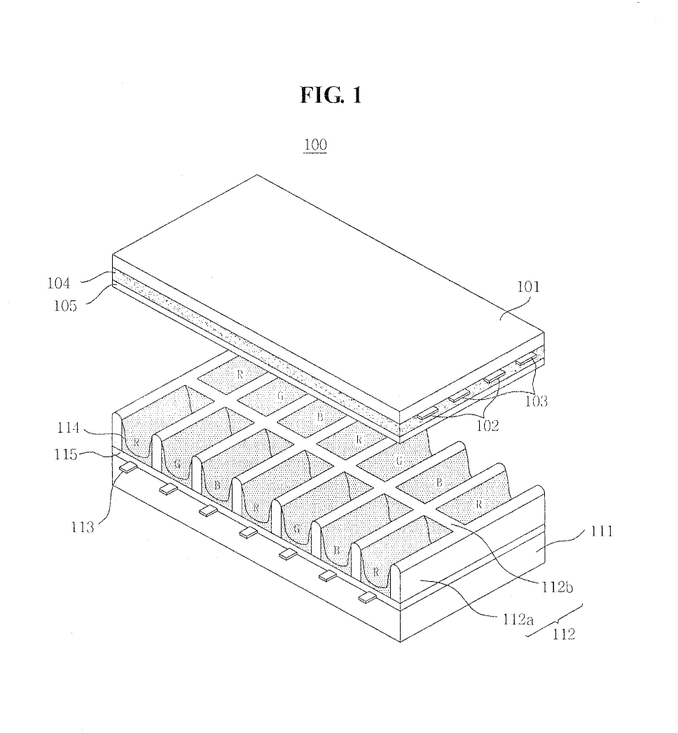

FIG. 1 illustrates a structure of a plasma display panel according to an exemplary embodiment.

As illustrated in FIG. 1, a plasma display panel 100 according to an exemplary embodiment includes a front substrate 101 and a rear substrate 111 which coalesce with each other. On the front substrate 101, a scan electrode 102 and a sustain electrode 103 are positioned parallel to each other. On the rear substrate 111, an address electrode 113 is positioned to intersect the scan electrode 102 and the sustain electrode 103.

An upper dielectric layer 104 is positioned on the scan electrode 102 and the sustain electrode 103 to provide electrical insulation between the scan electrode 102 and the sustain electrode 103.

A protective layer 105 is positioned on the upper dielectric layer 104 to facilitate discharge conditions. The protective layer 105 may include a material having a high secondary electron emission coefficient, for example, magnesium oxide (MgO).

A lower dielectric layer 115 is positioned on the address electrode 113 to provide electrical insulation of the address electrodes 113.

Barrier ribs 112 of a stripe type, a well type, a delta type, a honeycomb type, and the like, are positioned on the lower dielectric layer 115 to partition discharge spaces (i.e., discharge cells). A red (R) discharge cell, a green (G) discharge cell, and a blue (B) discharge cell, and the like, may be positioned between the front substrate 101 and the rear substrate 111. In addition to the red (R), green (G), and blue (B) discharge cells, a white (W) discharge cell or a yellow (Y) discharge cell may be positioned.

Each discharge cell partitioned by the barrier ribs 112 is filled with a discharge gas including xenon (Xe), neon (Ne), and so forth.

A phosphor layer 114 is positioned inside the discharge cells to emit visible light for an image display during the generation of an address discharge. For instance, first, second and third phosphor layer respectively emitting red (B), blue (B) and green (G) light may be positioned inside the discharge cells. In addition to the red (R), green (G) and blue (B) light, a phosphor layer emitting white or yellow light may be positioned.

A thickness of at least one of the phosphor layers 114 formed inside the red (R), green (G) and blue (B) discharge cells may be different from thicknesses of the other phosphor layers. For instance, thicknesses of the second and third phosphor layers inside the blue (B) and green (a) discharge cells may be larger than a thickness of the first phosphor layer inside the red (R) discharge cell. The thickness of the second phosphor layer may be substantially equal or different from the thickness of the third phosphor layer.

Widths of the red (R), green (G), and blue (B) discharge cells may be substantially equal to one another. Further, a width of at least one of the red (R), green (G), or blue (B) discharge cells may be different from widths of the other discharge cells. For instance, a width of the red (R) discharge cell may be the smallest, and widths of the green (G) and blue (B) discharge cells may be larger than the width of the red (R) discharge cell. The width of the green (G) discharge cell may be substantially equal or different from the width of the blue (B) discharge cell. Hence, a color temperature of an image displayed on the plasma display panel can be improved.

The plasma display panel 100 may have various forms of barrier rib structures as well as a structure of the barrier rib 112 illustrated in FIG. 1. For instance, the barrier rib 112 includes a first barrier rib 112b and a second barrier rib 112a. The barrier rib 112 may have a differential type barrier rib structure in which heights of the first and second barrier ribs 112b and 112a are different from each other.

In the differential type barrier rib structure, a height of the first barrier rib 112b may be smaller than a height of the second barrier rib 112a.

While FIG. 1 has been illustrated and described the case where the red (R), green (G) and blue (B) discharge cells are arranged on the same line, the red (R), green (G) and blue (B) discharge cells may be arranged in a different pattern. For instance, a delta type arrangement in which the red (R), green (G), and blue (B) discharge cells are arranged in a triangle shape may be applicable. Further, the discharge cells may have a variety of polygonal shapes such as pentagonal and hexagonal shapes as well as a rectangular shape.

While FIG. 1 has illustrated and described the case where the barrier rib 112 is formed on the rear substrate 111, the barrier rib 112 may be formed on at least one of the front substrate 101 or the rear substrate 111.

In FIG. 1, the upper dielectric layer 104 and the lower dielectric layer 115 each have a single-layered structure. However, at least one of the upper dielectric layer 104 or the lower dielectric layer 115 may have a multi-layered structure.

While the address electrode 113 positioned on the rear substrate 111 may have a substantially constant width or thickness, a width or thickness of the address electrode 113 inside the discharge cell may be different from a width or thickness of the address electrode 113 outside the discharge cell. For instance, a width or thickness of the address electrode 113 inside the discharge cell may be larger than a width or thickness of the address electrode 113 outside the discharge cell.

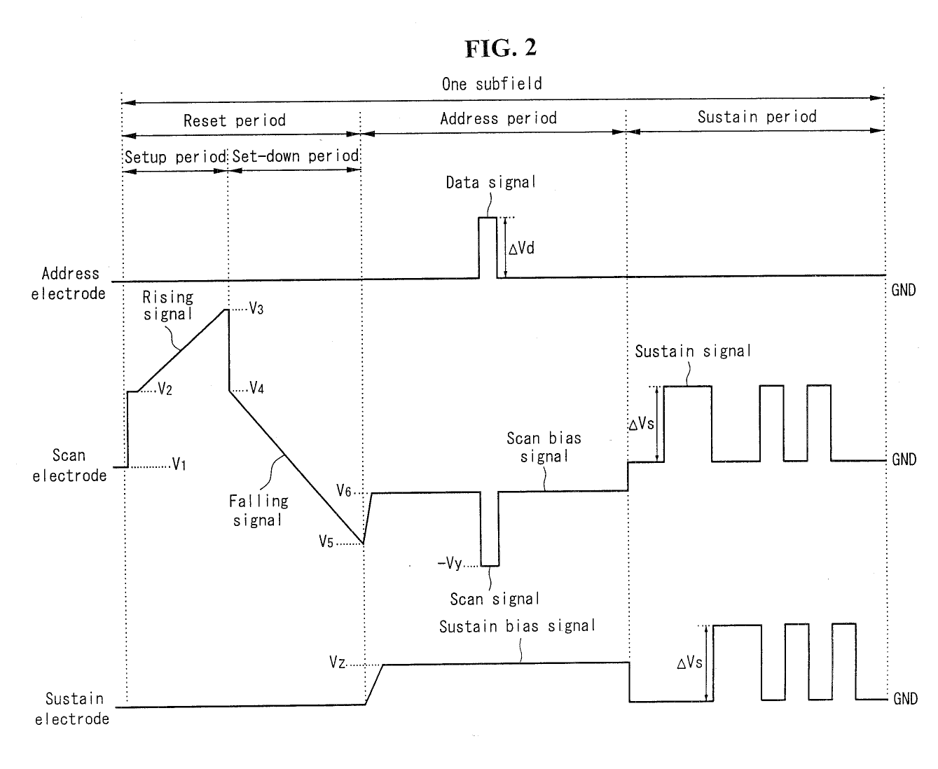

FIG. 2 illustrates an operation of the plasma display panel according to the exemplary embodiment. The exemplary embodiment is not limited to FIG. 2, and an operation method of the plasma display can be variously changed.

As illustrated in FIG. 2, during a reset period for initialization of wall charges, a reset signal is supplied to the scan electrode. The reset signal includes a rising signal and a falling signal. The reset period is further divided into a setup period and a set-down period.

During the setup period, the rising signal with a gradually rising voltage is supplied to the scan electrode. The rising signal generates a weak dark discharge (i.e., a setup discharge) inside the discharge cell during the setup period, thereby accumulating a proper amount of wall charges inside the discharge cell.

During the set-down period, a falling signal of a polarity direction opposite a polarity direction of the rising signal is supplied to the scan electrode. The falling signal generates a weak erase discharge (i.e., a set-down discharge) inside the discharge cell. Furthermore, the remaining wall charges are uniform inside the discharge cells to the extent that an address discharge can be stably performed.

During an address period following the reset period, a scan bias signal, which is maintained at a sixth voltage V6 higher than a lowest voltage of the falling signal, is supplied to the scan electrode.

A scan signal falling from the scan bias signal is supplied to the scan electrode.

A width of a scan signal supplied during an address period of at least one subfield may be different from a width of a scan signal supplied during address periods of the other subfields. For instance, a width of a scan signal in a subfield may be larger than a width of a scan signal in the next subfield in time order. Further, a width of the scan signal may be gradually reduced in the order of 2.6 μs, 2.3 μs, 2.1 μs, 1.9 μs, etc., or in the order of 2.6 μs, 2.3 μs, 2.3 μs, 2,1 μs, . . . , 1.9 μs, 1.9 μs, etc.

As above, when the scan signal is supplied to the scan electrode, a data signal corresponding to the scan signal is supplied to the address electrode.

As the voltage difference between the scan signal and the data signal is added to the wall voltage generated during the reset period, the address discharge occurs within the discharge cell to which the data signal is supplied.

A sustain bias signal is supplied to the sustain electrode during the address period to prevent the generation of the unstable address discharge by interference of the sustain electrode Z.

The sustain bias signal is substantially maintained at a sustain bias voltage Vz. The sustain bias voltage Vz is lower than a voltage Vs of a sustain signal and is higher than the ground level voltage GND.

During a sustain period following the address period, a sustain signal is alternately supplied to the scan electrode and the sustain electrode.

As the wall voltage within the discharge cell selected by performing the address discharge is added to the sustain voltage Vs of the sustain signal, every time the sustain signal is supplied, the sustain discharge, i.e., a display discharge occurs between the scan electrode and the sustain electrode.

A plurality of sustain signals are supplied during a sustain period of at least one subfield, and a width of at least one of the plurality of sustain signals may be different from widths of the other sustain signals. For instance, a width of a first supplied sustain signal among the plurality of sustain signals may be larger than widths of the other sustain signals. Hence, a sustain discharge can be more stable.

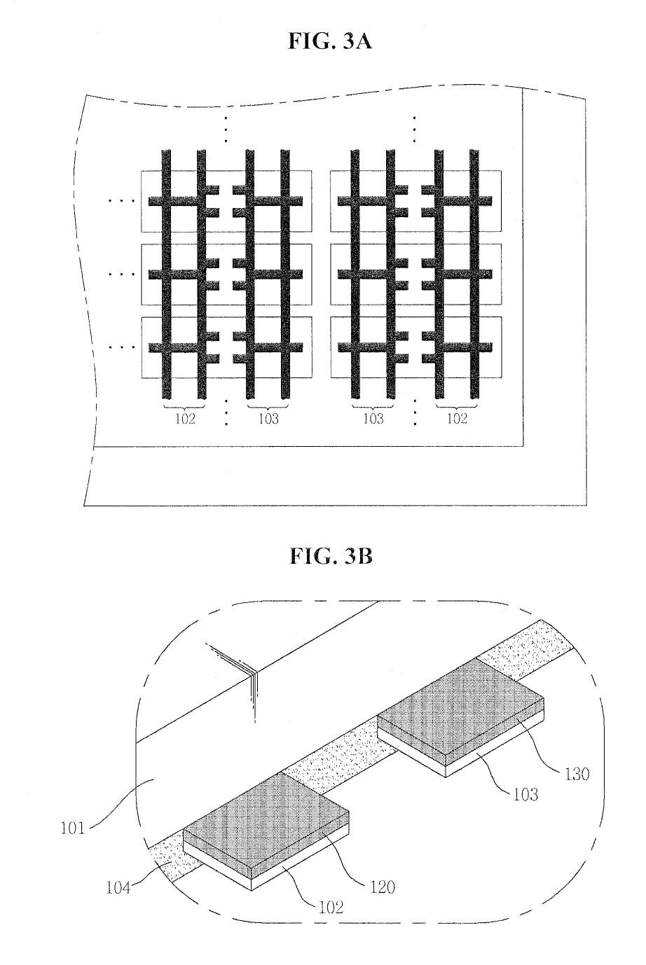

FIGS. 3A and 3B illustrate a scan electrode and a sustain electrode each having a single-layered structure.

As illustrated in FIGS. 3A and 3B, the scan electrode 102 and the sustain electrode 103 are positioned parallel to each other and have a single-layered structure.

Black layers 120 and 130 are positioned between the scan and sustain electrodes 102 and 103 and the front substrate 101.

The scan electrode 102 and the sustain electrode 103 may be formed of a metal material, which has excellent conductivity and is easy to mold, for instance, silver (Ag), gold (Au), copper (Cu) and aluminum (Al).

The scan and sustain electrodes 102 and 103 having the single-layered structure may be called an ITO-less electrode in which a transparent electrode is omitted. The scan electrode 102 and the sustain electrode 103 are a bus electrode.

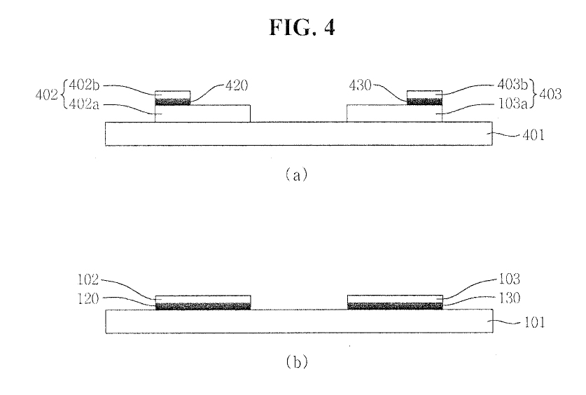

FIG. 4 illustrates a structure of a scan electrode and a sustain electrode;

In FIG. 4, (a) illustrates a scan electrode 402 and a sustain electrode 403 each having a multi-layered structure, (b) illustrates a scan electrode 102 and a sustain electrode 103 each having a single-layered structure.

In (a) of FIG. 4, the scan electrode 402 and the sustain electrode 403 each include transparent electrodes 402a and 403a and bus electrodes 402b and 403b.

The bus electrodes 402b and 403b may include a substantially opaque material, for instance, at least one of Ag, Au, Cu or Al. The transparent electrodes 402a and 403a may include a substantially transparent material, for instance, indium-tin-oxide (ITO).

Black layers 402a and 403a are formed between the transparent electrodes 402a and 403a and the bus electrodes 402b and 403b to prevent the reflection of external light caused by the bus electrodes 402b and 403b.

A manufacturing method of the scan electrode 402 and the sustain electrode 403 in (a) of FIG. 4 is as follows. First, a transparent electrode layer is formed on a front substrate 401. Then, the transparent electrode layer is patterned to form the transparent electrodes 402a and 403a.

A bus electrode layer is formed on the transparent electrodes 402a and 403a. Then, the bus electrode layer is patterned to form the bus electrodes 402b and 403b.

On the other hand, the scan electrode 102 and the sustain electrode 103 in (b) of FIG. 4 is formed by forming an electrode layer on a front substrate 101 and patterning the electrode layer. In other words, since the manufacturing method in (b) of FIG. 4 is simpler than the manufacturing method in (a) of FIG. 4, manufacturing time and the manufacturing cost in (b) of FIG. 4 are reduced.

In (a) of FIG. 4, since the transparent electrodes 402a and 403a are formed of relatively expensive ITO, the transparent electrodes 402a and 403a provide a cause of a rise in the manufacturing cost.

In (b) of FIG. 4, since relatively expensive ITO is not used, the manufacturing cost is reduced.

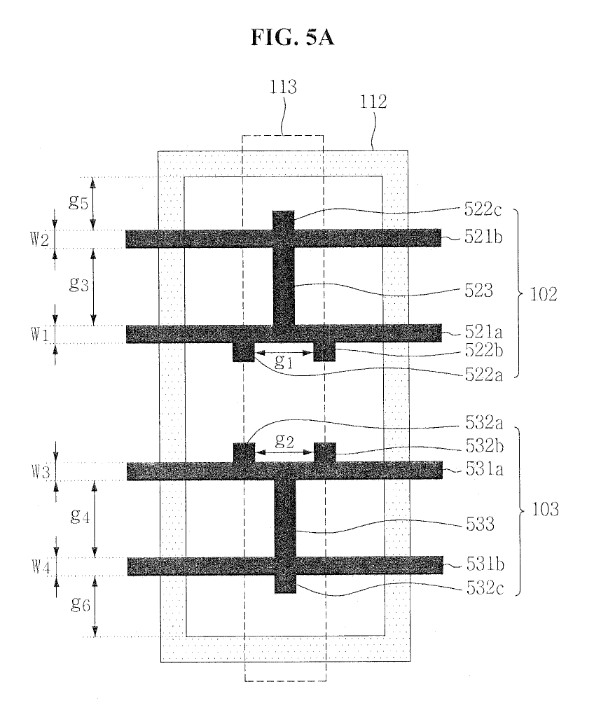

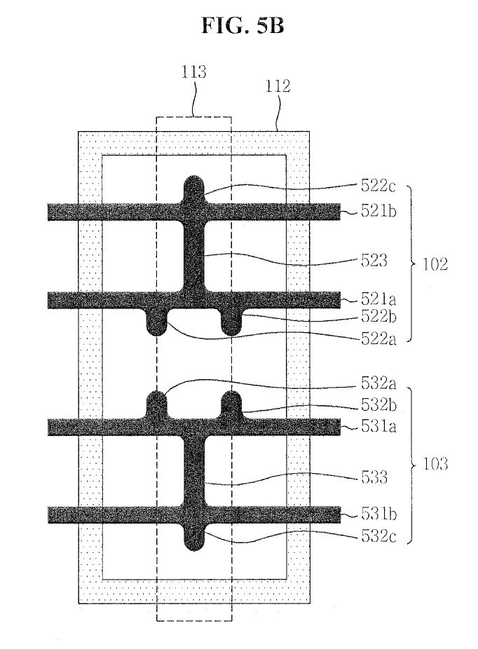

FIGS. 5A and 5B illustrate a configuration of a scan electrode and a sustain electrode.

As illustrated in FIG. 5A, the scan electrode 102 includes a plurality of line portions 521a and 521b intersecting the address electrode 113, and projecting portions 522a, 522b and 522c projecting from at least one of the line portions 521a and 521b. The sustain electrode 103 includes a plurality of line portions 531a and 531b intersecting the address electrode 113, and projecting portions 532a, 532b and 532c projecting from at the line portions 521a, 521b, 531a and 531b.

In FIG. 5A, the scan electrode 102 and the sustain electrode 103 each include three projecting portions. However, the number of projecting portions is not limited thereto. For instance, each of the scan electrode 102 and the sustain electrode 103 may include two projecting portions. The scan electrode 102 may include four projecting portions, and the sustain electrode 103 may include three projecting portions.

Further, the projecting portions 522c and 532c may be omitted from the scan electrode 102 and the sustain electrode 103, respectively.

The line portions 521a, 521b, 531a and 531b have a predetermined width, respectively. For instance, the first and second line portions 521a and 521b of the scan electrode 102 have widths of W1 and W2, respectively. The first and second line portions 531a and 531b of the sustain electrode 103 have widths of W3 and W4, respectively.

The widths W1, W2, W3 and W4 may have a substantially equal value. At least one of the widths W1, W2, W3 or W4 may have a different value. For instance, the widths W1 and W3 may be about 35 μm, and the widths W2 and W4 may be about 45 μm larger than the widths W1 and W3.

When an interval g3 between the first and second line portions 521a and 521b of the scan electrode 102 and an interval g4 between the first and second line portions 531a and 531b of the sustain electrode 103 are excessively large, it is difficult to diffuse a discharge generated between the scan electrode 102 and the sustain electrode 103 into the second line portion 521b of the scan electrode 102 and the second line portion 531b of the sustain electrode 103. On the other hand, the intervals g3 and g4 are excessively small, it is difficult to diffuse the discharge into the rear of the discharge cell. Accordingly, the intervals g3 and g4 may ranges from about 170 μm to 210 μm, respectively.

To sufficiently diffuse the discharge generated between the scan electrode 102 and the sustain electrode 103 into the rear of the discharge cell, a shortest interval g5 between the second line portion 521b of the scan electrode 102 and the barrier rib 112 in a direction parallel to the address electrode 113 and a shortest interval g6 between the second line portion 531b of the sustain electrode 103 and the barrier rib 112 in a direction parallel to the address electrode 113 may ranges from about 120 μm to 150 μm, respectively.

At least one of the projecting portions 522a, 522b, 522c, 532a, 532b and 532c projects from the line portions 521a, 521b, 531a and 531b toward the center of the discharge cell.

The projecting portions 522a, 522b, 522c, 532a, 532b and 532c are spaced apart from each other at a predetermined interval therebetween. For instance, the projecting portions 522a and 522b of the scan electrode 102 are spaced apart from each other at an interval of g1. The projecting portions 532a and 532b of the sustain electrode 103 are spaced apart from each other at an interval of g2. The intervals g1 and g2 may ranges from about 75 μm to 110 μm, respectively, so as to secure the discharge efficiency.

A length of at least one of the projecting portions 522a, 522b, 522c, 532a, 532b and 532c may be different from a length of the other projecting portions. Lengths of the projecting portions each having a different projecting direction may be different from each other. For instance, lengths of the projecting portions 522a and 522b of the scan electrode 102 may be different from a length of the projecting portion 522c, and lengths of the projecting portions 532a and 532b of the sustain electrode 103 may be different from a length of the projecting portion 532c.

The scan electrode 102 and the sustain electrode 103 each include a connection portion for connecting at least two line portions. For instance, the scan electrode 102 includes a connection portion 523 for connecting the first and second line portions 521a and 521b, and the sustain electrode 103 includes a connection portion 533 for connecting the first and second line portions 531a and 531b.

A discharge may start to occur the between the projecting portions 522a and 522b projecting from the first line portion 521a of the scan electrode 102 and the projecting portions 532a and 532b projecting from the first line portion 531a of the sustain electrode 103.

The discharge is diffused into the first line portion 521a of the scan electrode 102 and the first line portion 531a of the sustain electrode 103, and then is diffused into the second line portion 521b of the scan electrode 102 and the second line portion 531b of the sustain electrode 103 through the connection portions 523 and 533.

The discharge diffused into the second line portions 521b and 531b is diffused into the rear of the discharge cell through the projecting portion 522c of the scan electrode 102 and the projecting portion 532c of the sustain electrode 103.

As illustrated in FIG. 5B, at least one of the projecting portions 521a, 521b, 521c, 531a, 531b and 531c may have a portion with the curvature. At least one of the projecting portions 521a, 521b, 521c, 531a, 531b and 531c may have an end portion with the curvature.

Further, a portion connecting the projecting portions 521a, 521b, 521c, 531a, 531b and 531c to the line portions 521a, 521b, 531a and 531b may have a curvature.

Further, a portion connecting the line portions 521a, 521b, 531a and 531b to the connection portions 523 and 533 may have a curvature.

As above, when the scan electrode 102 and the sustain electrode 103 each have the portion with the curvature, the scan electrode 102 and the sustain electrode 103 can be manufactured more easily. Further, the excessive accumulation of wall charges on a predetermined portion of the scan electrode 102 and the sustain electrode 103 can be prevented during a driving of the panel, and thus the panel can be stably driven.

As above, when the scan electrode and the sustain electrode each have the single-layered structure, a firing voltage between the scan electrode and the sustain electrode rises and the driving efficiency and a luminance are lowered.

FIG. 6 illustrates a relationship between a single-layered electrode structure and a color representability.

In FIG. 6, (a) illustrates a scan electrode 701 and a sustain electrode 702 each having a multi-layered structure, and (b) illustrates a scan electrode 703 and a sustain electrode 704 each having a single-layered structure.

In (a) of FIG. 6, the scan electrode 701 and the sustain electrode 702 each include transparent electrodes 701a and 702a and bus electrodes 701b and 702b.

In (a) of FIG. 6, although an area of each of the bus electrodes 701b and 702b is small, an electrical conductivity of the scan electrode 701 and the sustain electrode 702 may riot be greatly reduced. Therefore, an excessive reduction in the driving efficiency can be prevented, and an aperture ratio of the panel can be maintained at a high level.

On the contrary, in (b) of FIG. 6, because a transparent electrode is omitted, an area of each of the scan electrode 703 and the sustain electrode 704 has to be wide so as to maintain an electrical conductivity of the scan electrode 701 and the sustain electrode 702 at a high level. Accordingly, an aperture ratio of the panel is excessively reduced and a luminance is excessively reduced.

In (b) of FIG. 6, the entire area of each of the scan electrode 703 and the sustain electrode 704 has to be small so as to prevent an excessive reduction in the luminance. Accordingly, a discharge diffusion level in (b) of FIG. 6 may be less than a discharge diffusion level in (a) of FIG. 6.

In other words, it is difficult to sufficiently diffuse a discharge starting to occur between the scan electrode 703 and the sustain electrode 704 into the rear of the discharge cell in (b) of FIG. 6. Accordingly, an emission area of visible light inside the discharge cell is not wide and may be concentrated in a specific area. Hence, a color sensitivity of a displayed image is reduced. In other words, the color representability is reduced in the scan electrode 703 and the sustain electrode 704 each having the single-layered structure.

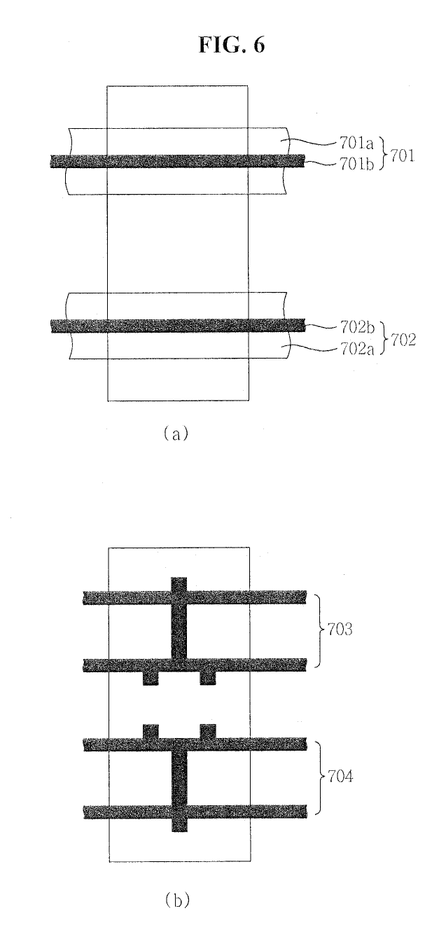

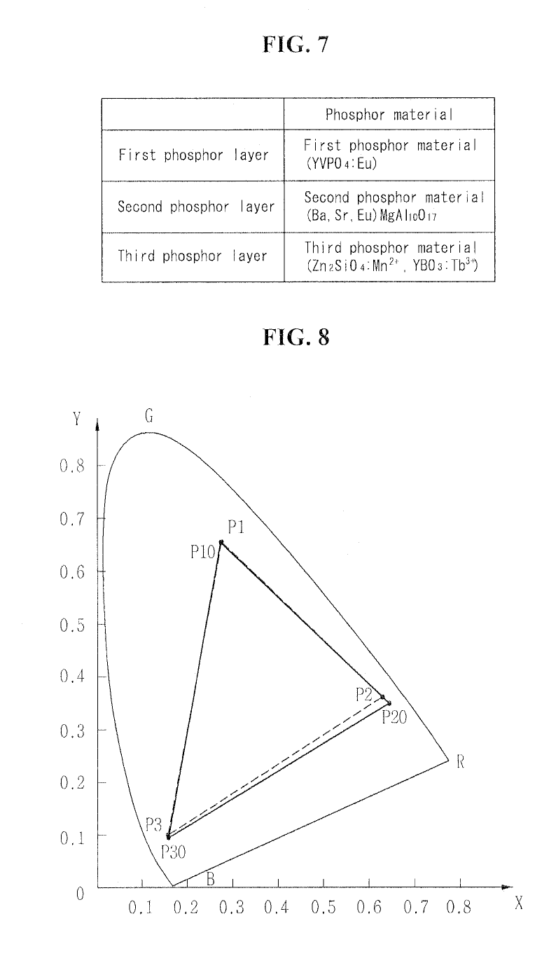

The first phosphor layer may include YVPO₄:Eu as a first phosphor material so as to prevent a reduction in the color representability. This will be described below with reference to FIG. 7.

FIG. 7 is a table showing a phosphor material.

As illustrated in FIG. 7, a second phosphor layer emitting blue light includes a second phosphor material having a white-based color

The second phosphor material is not particularly limited except the blue light emission. The second phosphor material may be (Ba, Sr, Eu)MgAl₁₀O₁₇ in consideration of an emitting efficiency of blue light.

A third phosphor layer emitting green light includes a third phosphor material having a white-based color.

The third phosphor material is not particularly limited except the green light emission. The third phosphor material may include Zn₂SiO₄:Mn⁺² and YBO₃:Tb⁺³ in consideration of an emitting efficiency of green light.

A first phosphor layer emitting red light includes a first phosphor material having a white-based color.

The first phosphor material includes YVPO₄:Eu emitting red light. Because a red light emission efficiency of YVPO₄:Eu is higher than a red light emission efficiency of another phosphor material (for instance, (Y, Gd)BO:Eu) emitting red light, a color sensitivity of the image can be improved. In other words, the color representability can be improved. This will be described below with reference to FIG. 8.

FIG. 8 is a graph showing color coordinates of the plasma display panel according to the exemplary embodiment.

A 1-typed panel and a 2-typed panel are manufactured. In the 1-typed panel, a first phosphor material is YVPO₄;Eu, a second phosphor material is (Ba, Sr, Eu)MgAl₁₀O₁₇, and a third phosphor material is a mixture mixing Zn₂SiO₄:Mn⁺² with YBO₃:Tb⁺³ in a ratio of 5:5. In the 2-typed panel, a first phosphor material is (Y, Gd)BO:Eu, a second phosphor material is (Ba, Sr, Eu)MgAl₁₀O₁₇, and a third phosphor material is a mixture mixing Zn₂SiO₄:Mn⁺² with YBGO₃:Tb⁺³ in a ratio of 5:5. Then, color coordinates are measured using a photodetector (MCPD-1000) in a state where the same image is displayed on the 1-typed and 2-typed panels.

As illustrated in FIG. 8, in the 2-typed panel, a green coordinate P1 has X-axis coordinate of about 0.276 and Y-axis coordinate of about 0.656; a red coordinate P2 has X-axis coordinate of about 0.630 and Y-axis coordinate of about 0,362; and a blue coordinate P3 has X-axis coordinate of about 0.157 and Y-axis coordinate of about 0.100.

In the 1-typed panel, a green coordinate P10 has X-axis coordinate of about 0.274 and Y-axis coordinate of about 0.655; a red coordinate P20 has X-axis coordinate of about 0.645 and Y-axis coordinate of about 0.350; and a blue coordinate P30 has X-axis coordinate of about 0.158 and Y-axis coordinate of about 0.095.

It can be seen from FIG. 8 that an area of a triangle formed by connecting the coordinates P10, P20 and P30 of the 1-typed panel is larger than an area of a triangle formed by connecting the coordinates P1, P2 and P3 of the 2-typed panel. It means that a red reproduction of the 1-typed panel including YVPO₄:Eu as the first phosphor material is more excellent than a red reproduction of the 2-typed panel including (Y, Gd)BO;Eu as the first phosphor material.

Although there is a difference in the eyesight depending on a viewer's taste, (Y, Gd)BO:Eu emits red light close to orange, and YVPO₄:Eu emits deep red light.

As above, because a discharge is not widely diffused in the scan electrode and the sustain electrode each having the single-layered structure, a color production is reduced. However, YVPO₄:Eu used as the first phosphor material can compensate for a reduction in the color production caused by the single-layered structure, and thus the image quality can be improved.

FIG. 9 is a table showing another implementation of a composition of a phosphor layer.

As illustrated in FIG. 9, a phosphor layer includes a pigment,

A first phosphor layer emitting red light may include a first phosphor material having a white-based color and a red pigment.

The red pigment has a red-based color. The first phosphor layer may have a red-based color by mixing the red pigment with the first phosphor material. The red pigment is riot particularly limited except the red-based color. The red pigment may include an iron (Fe)-based material in consideration of facility of powder manufacture, color, and manufacturing cost.

The Fe-based material may be a state of iron oxide in the first phosphor layer. For instance, the Fe-based material may be a state of αFe₂O₃ in the first phosphor layer.

The red pigment may include CdSe, CdS, and the like, in addition to the Fe-based material,

As above, since the first phosphor layer appears red due to the red pigment, a red image in a displayed image may be displayed more clearly. Hence, a red reproduction can be improved.

Further, since the red pigment absorbs light coming from the outside, a panel reflectance can be reduced and a contrast characteristic can be improved.

A second phosphor layer emitting blue light may include a second phosphor material having a white-based color and a blue pigment.

The blue pigment has a blue-based color. The second phosphor layer may have a blue-based color by mixing the blue pigment with the second phosphor material. The blue pigment is not particularly limited except the blue-based color. The blue pigment may include at least one of a cobalt (Co)-based material, a copper (Cu)-based material, a chrome (Cr)-based material, a nickel (Ni)-based material, an aluminum (Al)-based material, a titanium (Ti)-based material or a neodymium (Nd)-based material, in consideration of facility of powder manufacture, color, and manufacturing cost.

At least one of the Co-based material, the Cu-based material, the Cr-based material, the Ni-based material, the Al-based material, the Ti-based material or the Nd-based material may be a state of metal oxide in the second phosphor layer. For instance, the Co-based material may be a state of CoAl₂O₄ in the second phosphor layer.

As above, since the second phosphor layer appears blue due to the blue pigment, a blue image in a displayed image may be displayed more clearly. Hence, a blue reproduction can be improved.

Further, since the blue pigment absorbs light coming from the outside, a panel reflectance can be reduced and a contrast characteristic can be improved.

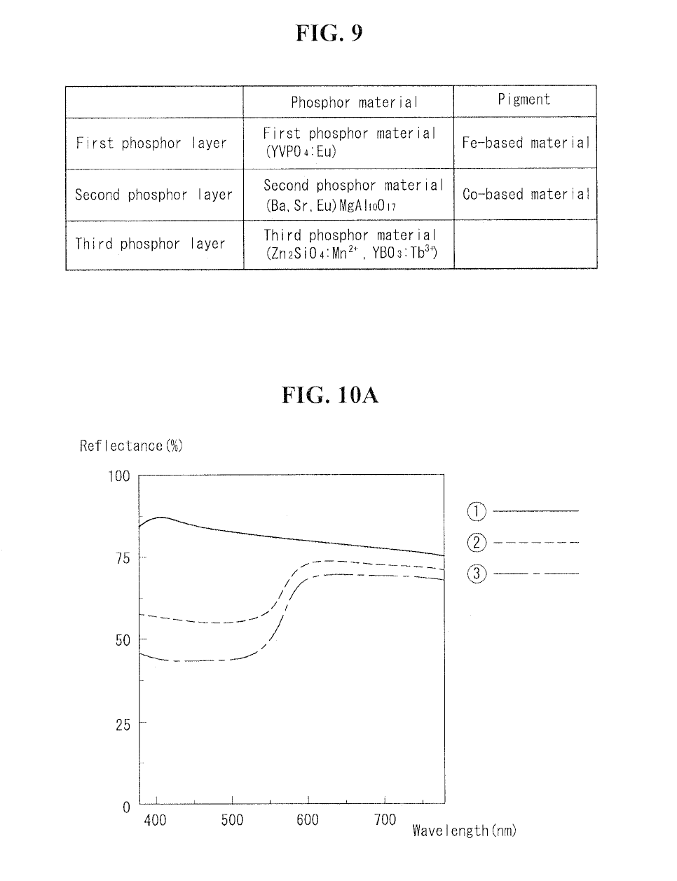

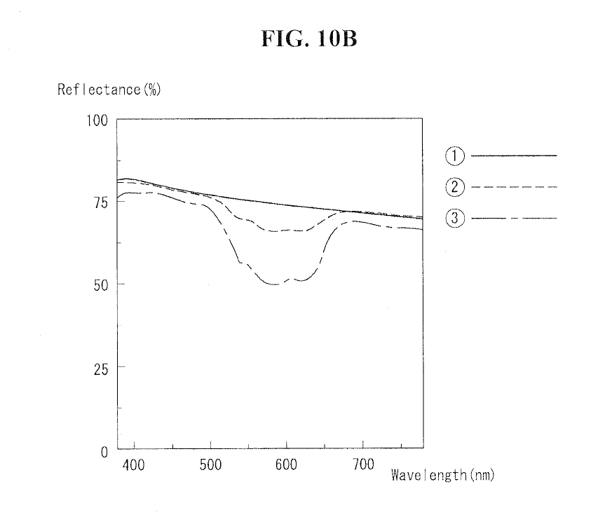

FIG. 10A is a graph showing a reflectance of a test model depending on a wavelength.

First, a 7-inch test model on which a first phosphor layer emitting red light from all discharge cells is positioned is manufactured. Then, light is directly irradiated on a barrier rib and the first phosphor layer of the test model in a state where a front substrate of the test model is removed to measure a reflectance of the test model.

The first phosphor layer includes a first phosphor material and a red pigment. The first phosphor material is (Y, Gd)BO:Eu. The red pigment is an Fe-based material, and the Fe-based material in a state of αFe₂O₃ is mixed with the first phosphor material.

In FIG. 10A, \textcircled{1} indicates a case where the first phosphor layer does not include the red pigment. \textcircled{2} indicates a case where the first phosphor layer includes the red pigment of 0.1 part by weight. \textcircled{3} indicates a case where the first phosphor layer includes the red pigment of 0.5 part by weight.

In case of \textcircled{1} not including the red pigment, a reflectance is equal to or more than about 75% at a wavelength of 400 nm to 750 nm. Because the first phosphor material having a white-based color reflects most of incident light, the reflectance in \textcircled{1} is high.

In case of \textcircled{e} including the red pigment of 0.1 part by weight, a reflectance is equal to or less than about 60% at a wavelength of 400 nm to 550 nm and ranges from about 60% to 75% at a wavelength more than 550 nm.

In case of \textcircled{3} including the red pigment of 0.5 part by weight, a reflectance is equal to or less than about 50% at a wavelength of 400 nm to 550 nm and ranges from about 50% to 70% at a wavelength more than 550 nm.

Because the red pigment having a red-based color absorbs incident light, the reflectances in \textcircled{2} and \textcircled{3} are less than the reflectance in \textcircled{1}.

FIG. 10B is a graph showing a reflectance of a test module depending on a wavelength. First, a 7-inch test model on which a second phosphor layer emitting blue light from all discharge cells is positioned is manufactured. Then, light is directly irradiated on a barrier rib and the second phosphor layer of the test model in a state where a front substrate of the test model is removed to measure a reflectance of the test model.

The second phosphor layer includes a second phosphor material and a blue pigment. The second phosphor material is (Ba, Sr, Eu)MgAl₁₀O₁₇. The blue pigment is a Co-based material, and the Co-based material in a state of CoAl₂O₄ is mixed with the second phosphor material.

In FIG. 10B, \textcircled{1} indicates a case where the second phosphor layer does not include the blue pigment. \textcircled{2} indicates a case where the second phosphor layer includes the blue pigment of 0.1 part by weight. \textcircled{3} indicates a case where the second phosphor layer includes the blue pigment of 1.0 part by weight.

In case of \textcircled{1} not including the blue pigment, a reflectance is equal to or more than about 72% at a wavelength of 400 nm to 750 nm. Because the second phosphor material having a white-based color reflects most of incident light, the reflectance in \textcircled{1} is high.

In case of \textcircled{2} including the blue pigment of 0.1 part by weight, a reflectance is equal to or more than about 74% at a wavelength of 400 nm to 510 nm, falls to about 60% at a wavelength of 510 nm to 650 nm, and rises to about 72%. at a wavelength more than 650 nm.

In case of \textcircled{3} including the blue pigment of 1.0 part by weight, a reflectance is at least 50% at a wavelength of 510 nm to 650 nm.

Because the blue pigment having a blue-based color absorbs incident light, the reflectances in \textcircled{2} and \textcircled{2} are less than the reflectance in \textcircled{1}. A reduction in the reflectance can improve the contrast characteristic, and thus the image quality can be improved.

A method of manufacturing the first phosphor layer will be described below as an example of a method of manufacturing the phosphor layer.

First, a powder of the first phosphor material including (Y, Gd)BO:Eu and a powder of the red pigment including αFe₂O₃ are mixed with a binder and a solvent to form a phosphor paste. In this case, the red pigment of a state mixed with gelatin may be mixed with the binder and the solvent. A viscosity of the phosphor paste may range from about 1,500 CP to 30,000 CP. An additive such as surfactant, silica, dispersion stabilizer may be added to the phosphor paste, as occasion demands.

The binder used may be ethyl cellulose-based or acrylic resin-based binder or polymer-based binder such as PMA or PVA. However, the binder is not particularly limited thereto. The solvent used may use α-terpineol, butyl carbitol, diethylene glycol, methyl ether, and so forth. However, the solvent is not particularly limited thereto.

The phosphor paste is coated inside the discharge cells partitioned by the barrier ribs. Then, a drying or firing process is performed on the coated phosphor paste to form the first phosphor layer.

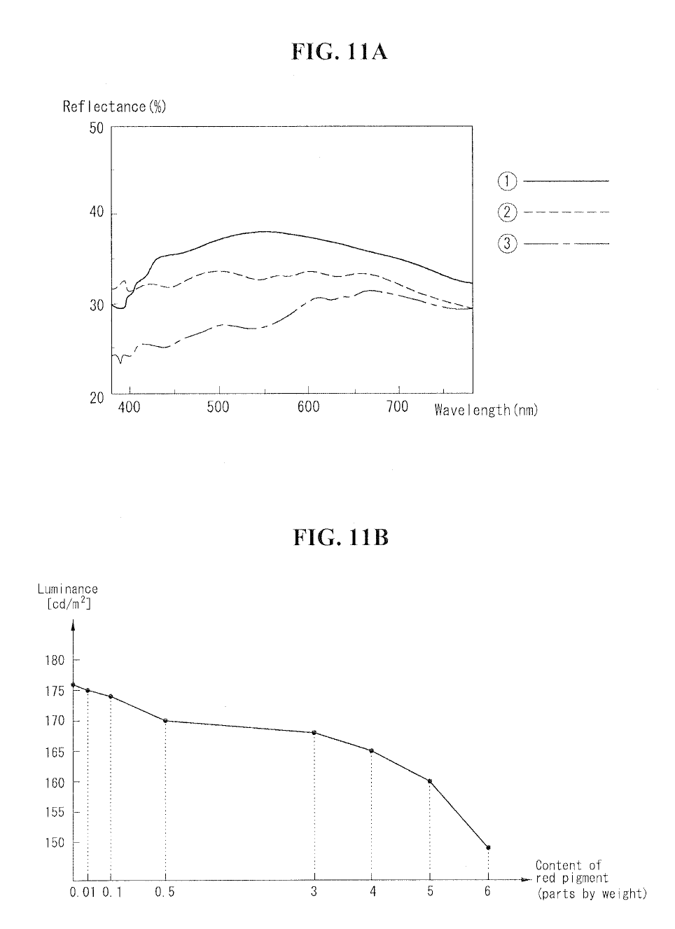

FIGS. 11A and 11B are graphs showing a reflectance and a luminance of the plasma display panel depending on changes in a content of red pigment, respectively.

In FIGS. 11A and 11B, the first phosphor layer is positioned inside the red discharge cell, the second phosphor layer is positioned inside the blue discharge cell, and the third phosphor layer is positioned inside the green discharge cell. Further, a reflectance and a luminance of the plasma display panel are measured depending on changes in a content of red pigment mixed with the first phosphor layer in a state where a blue pigment of 1.0 part by weight is mixed with the second phosphor layer. In this case, a reflectance and a luminance of the plasma display panel are measured in a panel state in which the front substrate and the rear substrate coalesce with each other.

The first phosphor material is (Y, Gd)BO:Eu. The red pigment is an Fe-based material, and the Fe-based material in a state of αFe₂O₃ is mixed with the first phosphor material.

The second phosphor material is (Ba, Sr, Eu)MgAl₁₀O₁₇. The blue pigment is a Co-based material, and the Co-based material in a state of CoAl₂O₄ is mixed with the second phosphor material.

In FIG. 11A, \textcircled{1} indicates a case where the first phosphor layer does not include the red pigment in a state where the second phosphor layer includes the blue pigment of 1.0 part by weight. \textcircled{2} indicates a case where the first phosphor layer includes the red pigment of 0.1 part by weight in a state where the second phosphor layer includes the blue pigment of 1.0 part by weight. \textcircled{3} indicates a case where the first phosphor layer includes the red pigment of 0.5 part by weight in a state where the second phosphor layer includes the blue pigment of 1.0 part by weight.

In case of \textcircled{1} not including the red pigment, a panel reflectance rises from about 33% to 38% at a wavelength of 400 nm to 550 nm. A panel reflectance falls to about 33% at a wavelength more than 550 nm. In other words, a panel reflectance has a high value of about 37% to 38% at a wavelength of 500 nm to 600 nm.

Because the first phosphor material having a white-based color reflects most of incident light, the panel reflectance in \textcircled{1} is relatively high although the blue pigment is mixed with the second phosphor layer.

In case of \textcircled{3} including the red pigment of 0.1 part by weight, a panel reflectance is equal to or less than about 34% at a wavelength of 400 nm to 750 nm, and has a relatively small value of about 33% to 34% at a wavelength of 500 nm to 600 nm.

In case of \textcircled{3} including the red pigment of 0.5 part by weight, a panel reflectance ranges from about 24% to 31.5% at a wavelength of 400 nm to 650 nm and falls to about 30% at a wavelength of 650 nm to 750 nm. Further, a panel reflectance has a relatively small value of about 27.5% to 29.5% at a wavelength of 500 nm to 600 nm.

As above, as a content of red pigment increases, the panel reflectance decreases.

There is a relatively great difference between the panel reflectance in \textcircled{1} not including the red pigment and the panel reflectance in \textcircled{2} and \textcircled{3} including the red pigment at a wavelength of 500 nm to 600 nm.

Because a wavelength of 500 nm to 600 nm mainly appears red, orange and yellow in visible light, a high panel reflectance at a wavelength of 500 nm to 600 nm means that a displayed image is close to red. In this case, because a color temperature is relatively low, a viewer may easily feel eyestrain and an image may be not clear.

On the other hand, a low panel reflectance at a wavelength of 500 nm to 600 nm, for instance, at a wavelength of 550 nm means that absorbance of red, orange and yellow light is high. Hence, a color temperature of a displayed image is relatively high, and thus an image can be clearer.

Accordingly, the relatively great difference between the panel reflectance in \textcircled{1} and the panel reflectance in \textcircled{2} and \textcircled{3} at a wavelength of 500 nm to 600 nm means that an excessive reduction in the color temperature can be prevented by mixing the red pigment with the first phosphor layer. Hence, the viewer can watch a clearer image.

Considering the description of FIG. 11A, a color temperature of the panel can be improved by setting the panel reflectance to be equal to or less than 30% at a wavelength of 500 nm to 600 nm, for instance, at a wavelength of 550 nm.

FIG. 11B is a graph showing a luminance of the same image depending on changes in a content of red pigment included in the first phosphor layer in a state where a content of blue pigment included in the second phosphor layer is fixed.

As illustrated in FIG. 11B, a luminance of an image displayed when the first phosphor layer does not include the red pigment is about 176 cd/m².

When a content of red pigment is 0.01 part by weight, a luminance of the image is reduced to about 175 cd/m². The reason why the red pigment reduces the luminance of the image is that particles of the red pigment cover a portion of the particle surface of the first phosphor material, thereby hindering ultraviolet rays generated by a discharge inside the discharge cell from being irradiated on the particles of the first phosphor material.

When a content of red pigment ranges from 0.1 to 3 parts by weight, a luminance of the image ranges from about 168 cd/m² to 174 cd/m².

When a content of red pigment ranges from 3 to 5 parts by weight, a luminance of the image ranges from about 160 cd/m² to 168 cd/M².

When a content of red pigment is equal to or more than 6 parts by weight, a luminance of the image is sharply reduced to a value equal to or less than about 149 cd/m². In other words, when a large amount of red pigment is mixed, the particles of the red pigment cover a large area of the particle surface of the first phosphor material and thus the luminance is sharply reduced.

Considering the description of FIGS. 11A and 11B, a content of red pigment may range from 0.01 to 5 parts by weight so as to prevent a reduction in the luminance while the panel reflectance is reduced. A content of red pigment may range from 0.1 to 3 parts by weight.

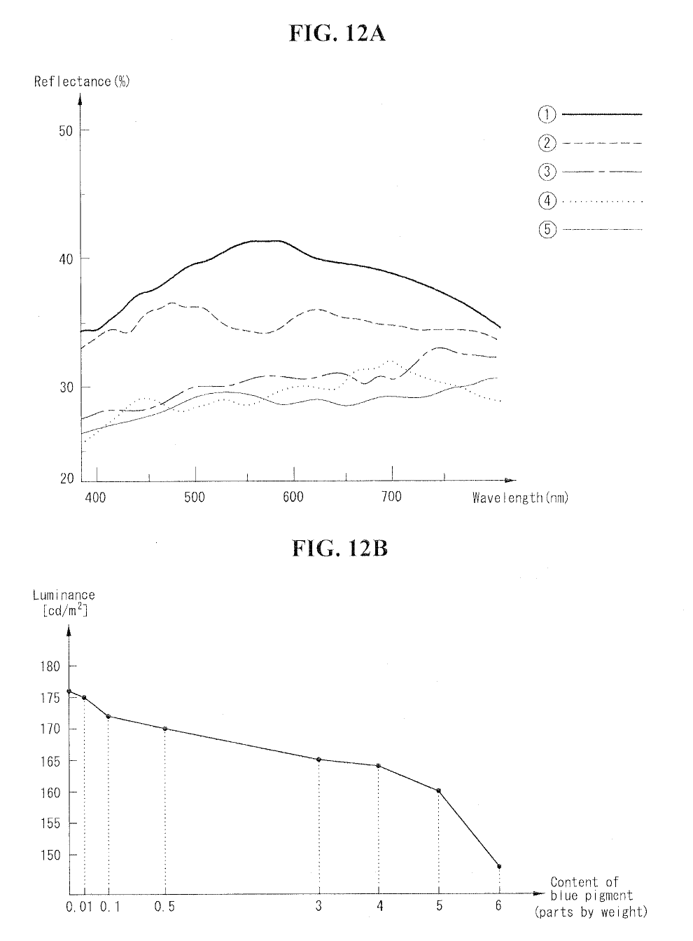

FIGS. 12A and 12B are graphs showing a reflectance and a luminance of a plasma display panel depending on changes in a content of blue pigment, respectively. A description in FIGS. 12A and 12B overlapping the description in FIGS. 11A and 11B is briefly made or entirely omitted.

In FIGS. 12A and 12B, the first phosphor layer is positioned inside the red discharge cell, the second phosphor layer is positioned inside the blue discharge cell, and the third phosphor layer is positioned inside the green discharge cell. Further, a reflectance and a luminance of the plasma display panel are measured depending on changes in a content of blue pigment mixed with the second phosphor layer in a state where the red pigment of 0.2 part by weight is mixed with the first phosphor layer. In this case, a reflectance and a luminance of the plasma display panel are measured in a panel state in which the front substrate and the rear substrate coalesce with each other. The other experimental conditions in FIGS. 12A and 12B are the same as the experimental conditions in FIGS. 11A and 11B.

In FIG. 12A, \textcircled{1} indicates a case where the second phosphor layer does not include the blue pigment in a state where the first phosphor layer includes the red pigment of 0.2 part by weight. \textcircled{2} indicates a case where the second phosphor layer includes the blue pigment of 0.1 part by weight in a state where the first phosphor layer includes the red pigment of 0.2 part by weight. \textcircled{3} indicates a case where the second phosphor layer includes the blue pigment of 0.5 part by weight in a state where the first phosphor layer includes the red pigment of 0.2 part by weight. \textcircled{4} indicates a case where the second phosphor layer includes the blue pigment of 3 parts by weight in a state where the first phosphor layer includes the red pigment of 0.2 part by weight. \textcircled{5} indicates a case where the second phosphor layer includes the blue pigment of 7 parts by weight in a state where the first phosphor layer includes the red pigment of 0.2 part by weight.

In case of \textcircled{1} not including the blue pigment, a panel reflectance rises from about 35% to 40.5% at a wavelength of 400 nm to 550 nm. A panel reflectance falls to about 35.5% at a wavelength more than 550 nm. In other words, a panel reflectance has a high value of about 39% to 40.5% at a wavelength of 500 nm to 600 nm.

Because the second phosphor material having a white-based color reflects most of incident light, the panel reflectance in \textcircled{1} is relatively high although the red pigment is mixed with the first phosphor layer.

In case of \textcircled{2} including the blue pigment of 0.1 part by weight, a panel reflectance is equal to or less than about 38% at a wavelength of 400 nm to 750 nm, and has a relatively small value of about 34% to 37% at a wavelength of 500 nm to 600 nm.

In case of \textcircled{3} including the blue pigment of 0.5 part by weight, a panel reflectance ranges from about 26% to 29% at a wavelength of 400 nm to 650 nm and falls from about 28% to 32.5% at a wavelength of 650 nm to 750 nm. Further, a panel reflectance has a relatively small value of about 28% to 29% at a wavelength of 500 nm to 600 nm.

In case of \textcircled{4} including the blue pigment of 3 parts by weight, a panel reflectance ranges from about 22.5% to 29% at a wavelength of 400 nm to 650 nm and ranges from about 29% to 31% at a wavelength of 650 nm to 750 nm. Further, a panel reflectance has a relatively small value of about 26.5% to 28% at a wavelength of 500 nm to 600 nm.

In case of \textcircled{5} including the blue pigment of 7 parts by weight, a panel reflectance ranges from about 25% to 28% at a wavelength of 400 nm to 700 nm and ranges from about 28% to 30% at a wavelength more than 700 nm.

FIG. 12B is a graph showing a luminance of the same image depending on changes in a content of blue pigment included in the second phosphor layer in a state where a content of red pigment included in the first phosphor layer is fixed.

As illustrated in FIG. 12B, a luminance of an image displayed when the second phosphor layer does not include the blue pigment is about 176 cd/m².

When a content of blue pigment is 0.01 part by weight, a luminance of the image is about 175 cd/m².

When a content of blue pigment is 0.1 part by weight, a luminance of the image is about 172 cd/m².

When a content of blue pigment ranges from 0.5 to 4 parts by weight, a luminance of the image has a stable value of about 164 cd/m² to 170 cd/m².

When a content of blue pigment ranges from 4 to 5 parts by weight, a luminance of the image ranges from about 160 cd/m² to 164 cd/m².

When a content of blue pigment exceeds 6 parts by weight, a luminance of the image is sharply reduced to a value equal to or less than about 148 cd/m². In other words, when a large amount of blue pigment is mixed, particles of the blue pigment cover a large area of the particle surface of the second phosphor material and thus the luminance is sharply reduced.

Considering the description of FIGS. 12A and 12B, a content of blue pigment may range from 0.01 to 5 parts by weight so as to prevent a reduction in the luminance while the panel, reflectance is reduced. A content of blue pigment may range from 0.5 to 4 parts by weight.

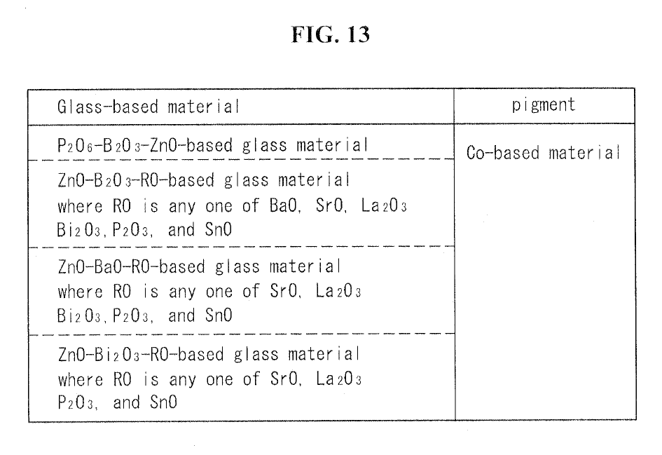

FIG. 13 illustrates a composition of an upper dielectric layer.

As illustrated in FIG. 13, an upper dielectric layer includes a glass-based material and a pigment, and has a blue-based color due to the pigment.

The glass-based material is not particularly limited. The glass-based material may be any one of P₂O₆—B₂O₃—ZnO-based glass material, ZnO—B₂O₃—RO-based glass material (where RO is any one of BaO, SrO, La₂O₃, Bi₂O₃, P₂O₃ and SnO), Zn—BaO—RO-based glass material (where RO is any one of SrO, La₂O₃, Bi₂O₃, P₂O₃ and SnO), and ZnO—Bi₂O₃—RO-based glass material (where RO is any one of SrO, La₂O₃, P₂O₃ and SnO), or a mixture of at least two of the above glass-based materials.

The pigment included in the upper dielectric layer is not particularly limited except that the upper dielectric layer has a blue-based color. The pigment may include at least one of a Co-based material, a Cu-based material, a Cr-based material, a Ni-based material, an Al-based material, a Ti-based material, a Ce-based material, a Mn-based material or a Nd-based material, in consideration of the facility of powder manufacture, the color, and the manufacturing cost.

An example of a method of manufacturing the upper dielectric layer is as follows.

First, a glass-based material and a pigment are mixed. For instance, P₂O₆—B₂O₃—ZnO-based glass material and the Co-based material as the pigment are mixed.

A glass is manufactured using the glass-based material mixed with the pigment. In this case, a blue glass having a blue-based color due to the Co-based material is manufactured.

The manufactured blue glass is grinded to manufacture a blue glass powder. The particle size of the blue glass powder may range from about 0.1 μm to 10 μm.

The blue glass powder is mixed with a binder, a solvent, and the like, to manufacture a dielectric paste. An additive such as a dispersion stabilizer may be added to the dielectric paste.

The dielectric paste is coated on the front substrate on which the scan electrode and the sustain electrode are formed. Then, the coated dielectric paste is dried and fired to form the upper dielectric layer.

Accordingly, the upper dielectric layer manufactured using the above manufacturing method can have a blue-based color.

Since the above description is only one example of the manufacturing method of the upper dielectric layer, the exemplary embodiment is not limited thereto. For instance, the upper dielectric layer may be manufactured using a laminating method.

As above, since the upper dielectric layer includes the Co-based material as the pigment, a blue reproduction in a displayed image can be improved. In this case, when YVPO₄:EU is used as the first phosphor material, the reproduction of red as well as blue in a displayed image can be improved although the scan electrode and the sustain electrode each have the single-layered structure.

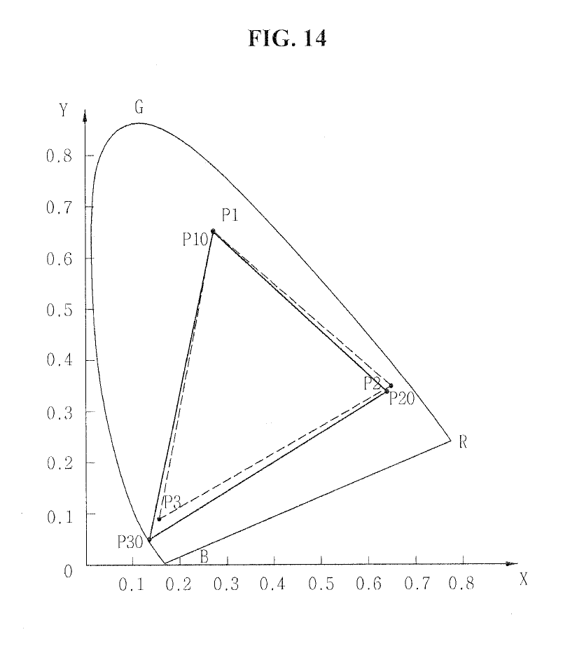

FIG. 14 is a graph showing color coordinates of the plasma display panel when an upper dielectric layer includes a Co-based material as a pigment.

A 1-typed panel in which an upper dielectric layer includes a Co-based material of 0.2 part by weight and a 2-typed panel in which an upper dielectric layer does not include a pigment are manufactured. Then, color coordinates are measured using a photodetector (MCPD-1000) in a state where the same image is displayed on the 1-typed and 2-typed panels.

As illustrated in FIG. 14, in the 2-typed panel, a green coordinate P1 has X-axis coordinate of about 0.272 and Y-axis coordinate of about 0.653; a red coordinate P2 has X-axis coordinate of about 0.649 and Y-axis coordinate of about 0.349; and a blue coordinate P3 has X-axis coordinate of about 0.156 and Y-axis coordinate of about 0.090.

In the 1-typed panel, a green coordinate P10 has X-axis coordinate of about 0.272 and Y-axis coordinate of about 0.651; a red coordinate P20 has X-axis coordinate of about 0.640 and Y axis coordinate of about 0.338; and a blue coordinate P30 has X-axis coordinate of about 0.135 and Y-axis coordinate of about 0.050.

It can be seen from FIG. 14 that a triangle formed by connecting the coordinates P10, P20 and P30 of the 1-typed panel leans toward the origin of the coordinate axes as compared with a triangle formed by connecting the coordinates P1, P2 and P3 of the 2-typed panel. This means that the blue reproduction of the 1-typed panel is more excellent the blue reproduction of the 2-typed panel. In other words, a color temperature of the 1-typed panel is higher than a color temperature of the 2-typed panel, and thus the image quality is higher.

When the upper dielectric layer includes an excessively large amount of Co-based material, a transmittance of the upper dielectric layer is reduced and thus a luminance of a displayed image is excessively reduced. On the other hand, when the upper dielectric layer includes an excessively small amount of Co-based material, an increase width of the color temperature and an improvement effect of the color reproduction are small.

Further, when the amount of Co-based material is constant, a reflectance is lowered due to an increase in a thickness of the upper dielectric layer and thus a contrast characteristic is improved. However, a transmittance of the upper dielectric layer is lowered and thus a luminance of a displayed image is lowered. When the thickness of the upper dielectric layer is constant, a reflectance is lowered due to an increase in the amount of Co-based material and thus a contrast characteristic is improved. However, a transmittance of the upper dielectric layer is lowered and thus a luminance of a displayed image is lowered.

Accordingly, the thickness of the upper dielectric layer may be determined depending on the amount of Co-based material so as to raise the transmittance of the upper dielectric layer while the reflectance is lowered.

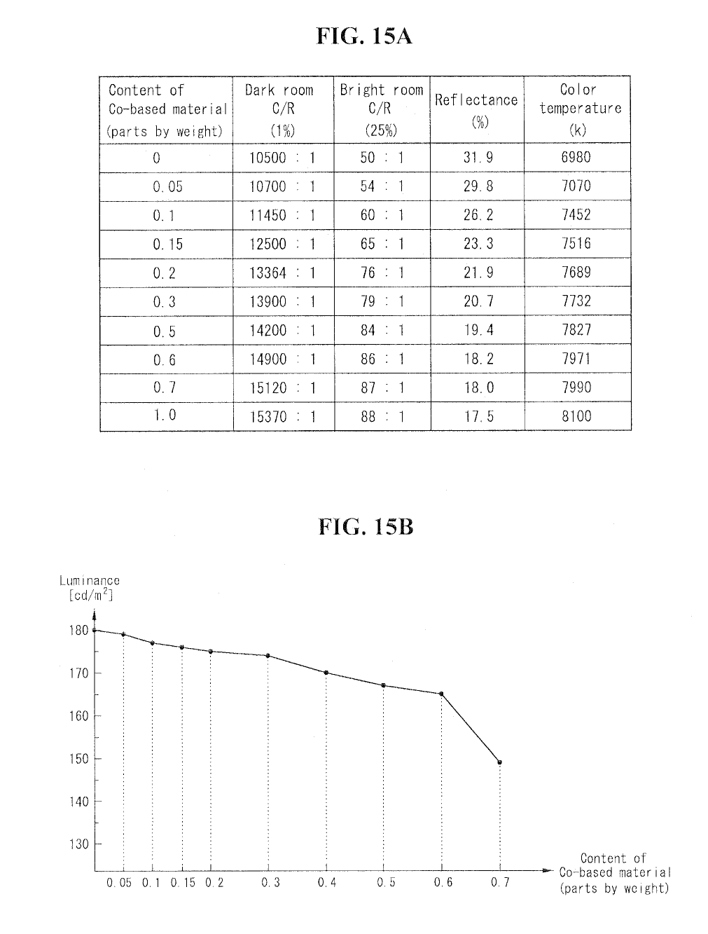

FIG. 15A is a table measuring a dark room contrast ratio, a bright room contrast ratio, a reflectance and a color temperature of the panel when a content of Co-based material used as a pigment included in the upper dielectric layer is 0, 0.05, 0.1, 0.15, 0.2, 0.3, 0.5, 0.6, 0.7, and 1.0 part by weight, respectively. FIG. 15B is a graph showing a luminance of the panel under the same conditions as FIG. 15A. A thickness of the upper dielectric layer is fixed to 38 μm, and a first phosphor layer includes a red pigment of 0.2 part by weight.

The dark room contrast ratio measures a contrast ratio in a state where an image with a window pattern corresponding to 1% of the screen size is displayed in a dark room.

The bright room contrast ratio measures a contrast ratio in a state where an image with a window pattern corresponding to 25% of the screen size is displayed in a bright room.

As illustrated in FIG. 15A, when the upper dielectric layer does not include Co-based material as the pigment, a dark room contrast ratio is 10500:1, a bright room contrast ratio is 50:1, a reflectance is 31.9%, and a color temperature is 6980K.

When the content of Co-based material is 0.05 part by weight, the dark room contrast ratio is 10700:1, the bright room contrast ratio is 54:1, the reflectance is 29.8%, and the color temperature is 7070K.

As above, when the upper dielectric layer includes a small amount of Co-based material equal to or less than 0.05 part by weight, the contrast ratio is reduced, the reflectance is high, and the color temperature is low.

When the content of Co-based material is 0.1 part by weight, the dark room contrast ratio is 11450:1, the bright room contrast ratio is 60:1, the reflectance is 26.2%, and the color temperature is 7452K. In other words, as the content of Co-based material increases, the contrast ratio increases, the reflectance is reduced, and the color temperature rises.

The upper dielectric layer has a blue-based color due to the properties of the Co-based material, and thus can absorb light coming from the outside. Hence, the contrast characteristic is improved and the reflectance is reduced.

Further, when visible light coming from the inside of the panel is emitted to the outside of the panel through the upper dielectric layer having a blue-based color, blue visible light can be more clearly emitted due to the upper dielectric layer. Hence, the color temperature can be improved.

When the content of Co-based material ranges from 0.15 to 0.3 part by weight, the dark room contrast ratio ranges from 12500:1 to 13900:1, the bright room contrast ratio ranges from 65:1 to 79:1, the reflectance ranges from 20.7% to 23.3%, and the color temperature ranges from 7516K to 7732K. In other words, when the content of Co-based material ranges from 0.15 to 0.3 part by weight, the contrast ratio, the reflectance and the color temperature can be improved.

When the content of Co-based material is equal to or more than 0.5 part by weight, the dark room contrast ratio is equal to or more than 14200:1, the bright room contrast ratio is equal to or more than 84:1, the reflectance is equal to or less than 19.4%, and the color temperature is equal to or more than 7827K.

As illustrated in FIG. 15B, when the upper dielectric layer does not include the Co-based material as the pigment, a luminance of a displayed image is about 180 cd/m².

When the content of Co-based material is 0.05 part by weight, the luminance is reduced to about 179 cd/m². Because the upper dielectric layer has a blue-based color due to the Co-based material, a transmittance of the upper dielectric layer is reduced and thus the luminance is reduced.

When the content of Co-based material is 0.1 part by weight, the luminance is about 177 cd/m². When the content of Co-based material ranges from 0.15 to 0.3 part by weight, the luminance ranges from about 174 to 176 cd/m².

When the content of Co-based material ranges from 0.4 to 0.6 part by weight, the luminance ranges from about 165 to 170 cd/m².

When the upper dielectric layer includes a large amount of Co-based material equal to or more than 0.7 part by weight, the transmittance of the upper dielectric layer is excessively reduced. Hence, the luminance is sharply reduced to a value equal to or less than about 149 cd/m².

Considering the description of FIGS. 15A and 15B, the content of Co-based material used as the pigment included in the upper dielectric layer may range from 0.01 to 0.6 part by weight so as to prevent a reduction in the luminance caused by an excessive reduction in the transmittance of the upper dielectric layer while the reflectance is reduced and the contrast ratio and the color temperature increase. Further, the content of Co-based material may range from 0.15 to 0.3 part by weight.

The pigment included in the upper dielectric layer may include at least one of a Cu-based material, a Cr-based material, a Ni-based material, an Al-based material, a Ti-based material, a Ce-based material, a Mn-based material or an Nd-based material, in addition to the Co-based material used as a main material.

In case that the Ni-based material is added to the Co-based material, the upper dielectric layer may be dark blue. Therefore, an image of dark blue can be more clearly displayed on the screen. When an excessively large amount of Ni-based material is added, the transmittance of the upper dielectric layer can be excessively reduced. Therefore, a content of Ni-based material may range from 0.1 to 0.2 part by weight.

In case that the Cr-based material is added to the Co-based material, the upper dielectric layer may have a mixed color of red and blue. Therefore, an image with the mixed color can be more clearly displayed on the screen. In other words, a color representable range of the image can increase. A content of Cr-based material may range from 0.1 to 0.3 part by weight.

In case that the Cu-based material is added to the Co-based material, the upper dielectric layer may have a mixed color of green and blue. Therefore, an image with the mixed color can be more clearly displayed on the screen. In other words, a color representable range of the image can increase. A content of Cu-based material may range from 0.03 to 0.09 part by weight.

In case that the Ce-based material is added to the Co-based material, the upper dielectric layer may have a mixed color of yellow and blue. Therefore, an image with the mixed color can be more clearly displayed on the screen. In other words, a color representable range of the image can increase. A content of Ce-based material may range from 0.1 to 0.3 part by weight.

In case that the Mn-based material is added to the Co-based material, a blue color of the upper dielectric layer may be deep. Therefore, a color temperature of a displayed image can increase. A content of Mn-based material may range from 0.2 to 0.6 part by weight.

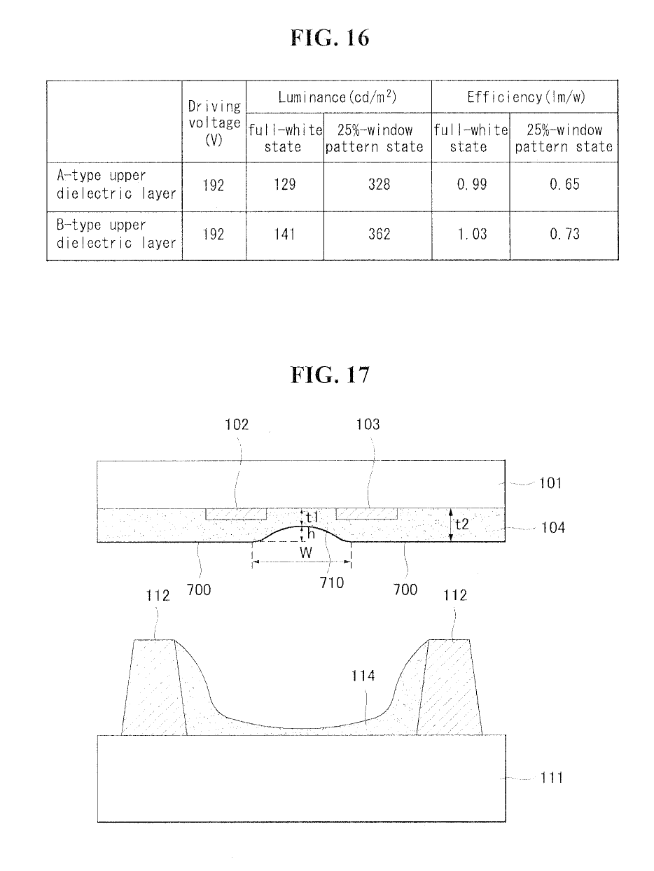

FIG. 16 is a table showing a luminance and an efficiency in each of an A-type upper dielectric layer and a B type upper dielectric layer.

Each of the luminance and the efficiency are measured in a full white state, where all the discharge cells are turned on, and in a state where an image with a window pattern corresponding to 25% of the screen size is displayed.

The A-type upper dielectric layer is formed of PbO—B₂O₃—SiO₂ glass and includes lead (Pb) exceeding 1,000 ppm (parts per million). The B-type upper dielectric layer includes Pb equal to or less than 1,000 ppm.

As illustrated in FIG. 16, in the A-type upper dielectric layer, when a driving voltage of 192V is applied between the scan electrode and the sustain electrode, the luminance of light is about 129 cd/m² and the efficiency is 0.99 lm/W in the full-white state, and the luminance of light is about 328 cd/m² and the efficiency is 0.65 lm/W in the state of 25%-window pattern.

In the B-type upper dielectric layer, when a driving voltage of 192V is applied between the scan electrode and the sustain electrode, the luminance of light is about 141 cd/m² and the efficiency is 1.03 lm/W in the full white state, and the luminance of light is about 362 cd/m² and the efficiency is 0.73 lm/W in the state of 25%-window pattern.

The luminance and the efficiency of the B-type upper dielectric layer are larger than the luminance and the efficiency of the A-type upper dielectric layer. The reason is that a capacitance of the B type upper dielectric layer including the Pb content less than the Pb content of the A-type upper dielectric layer is lower than a capacitance of the A-type upper dielectric layer, and thus a discharge current is reduced.

As above, when the Pb content of the upper dielectric layer is equal to or less than 1,000 ppm, a reduction in the luminance caused by a reduction in a transmittance of the upper dielectric layer can be compensated even if the upper dielectric layer includes a Co-based material as a pigment.

If Pb is accumulated inside the human body, Pb is a toxic material capable of adversely affecting the human body. Accordingly, when the upper dielectric layer includes Pb equal to or less than 1,000 ppm in the plasma display panel according to the exemplary embodiment, an influence of Pb on the human body can be reduced.

FIG. 17 illustrates another structure of an upper dielectric layer.

As illustrated in FIG. 17, the upper dielectric layer 104 includes a convex portion 700 and a concave portion 710 with a thickness smaller than a thickness of the convex portion 700.

The concave portion 710 may be positioned between the scan electrode 102 and the sustain electrode 103.

A largest thickness of the upper dielectric layer 104 (i.e., a thickness of the upper dielectric layer 104 in the convex portion 700) is t2, and a thickness of the upper dielectric layer 104 in the concave portion 710 is t1. A depth of the concave portion 710 is h, and a width of the concave portion 710 is W.

When a discharge occurs by applying a driving signal to the scan electrode 102 and the sustain electrode 103, most of wall charges may be accumulated on the concave portion 710. Therefore, a discharge path can shorten due to the structure of the upper dielectric layer 104 of FIG. 17. As a result, a firing voltage between the scan electrode 102 and the sustain electrode 103 is lowered and thus the driving efficiency can be improved.

A transmittance of the upper dielectric layer 104 with a blue-based color by including a Co-based material as a pigment is smaller than a transmittance of the transparent upper dielectric layer 104 not including the Co-based material. Hence, a luminance of a displayed image may be reduced.

On the contrary, as illustrated in FIG. 17, when the upper dielectric layer 104 includes the convex portion 700 and the concave portion 710, a firing voltage between the scan electrode 102 and the sustain electrode 103 can be lowered and thus a reduction in the luminance caused by the Co-based material can be compensated.

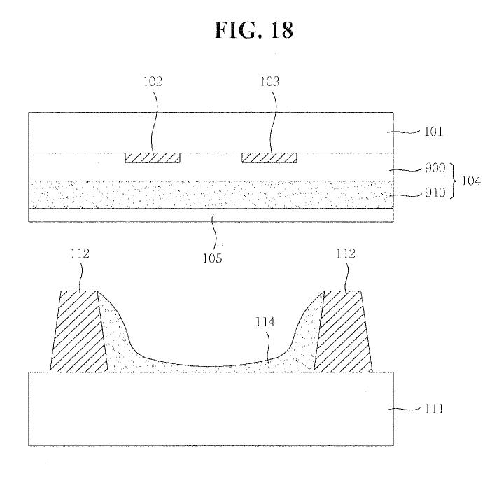

FIG. 18 illustrates another structure of an upper dielectric layer.

As illustrated in FIG. 18, the upper dielectric layer 104 has a two-layered structure. For instance, the upper dielectric layer 104 includes a first upper dielectric layer 900 and a second upper dielectric layer 910 which are stacked in turn.

At least one of the first upper dielectric layer 900 or the second upper dielectric layer 910 may include a pigment. If the upper dielectric layer 104 includes a metal pigment, a permittivity of the upper dielectric layer 104 may be reduced.

It is advantageous that a permittivity of the first upper dielectric layer 900 is relatively high because the first upper dielectric layer 900 covers the scan electrode 102 and the sustain electrode 103 and provides insulation between the scan electrode 102 and the sustain electrode 103. Therefore, the first upper dielectric layer 900 may not include a pigment, and the second upper dielectric layer 910 positioned on the first upper dielectric layer 900 may include a pigment.

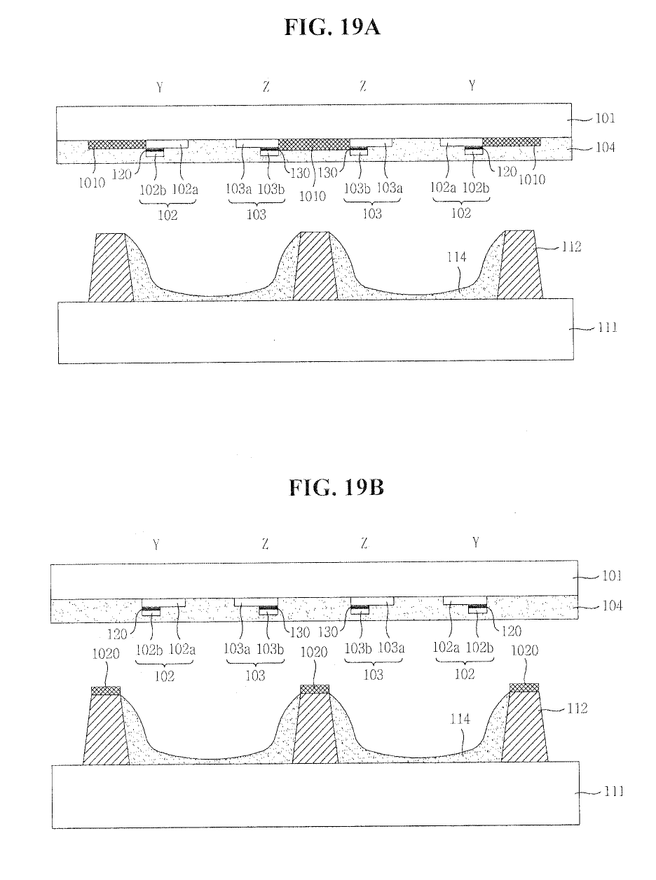

FIGS. 19A and 19B illustrate another structure of the plasma display panel according to the exemplary embodiment.

As illustrated in FIG. 19A, a black matrix 1010 overlapping the barrier rib 112 is positioned on the front substrate 101. The black matrix 1010 absorbs incident light, and thus suppresses the reflection of light caused by the barrier rib 112. Hence, a panel reflectance is reduced and a contrast characteristic can be improved.

In FIG. 19A, the black matrix 1010 is positioned on the front substrate 101. However, the black matrix 1010 may be positioned on the upper dielectric layer (not shown).

Black layers 120 and 130 are positioned between the transparent electrodes 102a and 103a and the bus electrodes 102b and 103b, respectively. The black layers 120 and 130 prevent the reflection of light caused by the bus electrodes 102b and 103b, thereby reducing a panel reflectance

As illustrated in FIG. 19B, a top black matrix 1020 is formed on the barrier rib 112. Since the Lop black matrix 1020 reduces a panel reflectance, a black matrix may not be formed on the front substrate 101.

As described above, when the upper dielectric layer 104 includes a pigment and the first phosphor layer includes a red pigment, the panel reflectance can be further reduced.

The black layers 120 and 130, the black matrix 1010 and the top black matrix 1020 may be omitted from the plasma display panel. Because the pigment mixed with the upper dielectric layer 104 or the red pigment mixed with the first phosphor layer can sufficiently reduce the panel reflectance, a sharp increase in the panel reflectance can be prevented although the black layers 120 and 130, the black matrix 1010 and the top black matrix 1020 are omitted.

A removal of the black layers 120 and 130, the black matrix 1010 and the top black matrix 1020 can make a manufacturing process of the panel simpler, and reduce the manufacturing cost.

A width of at least one of the black matrix 1010 of FIG. 19A or the top black matrix 1020 of FIG. 19B may be smaller than an upper width of the barrier rib 112. In this case, an aperture ratio can be sufficiently secured and an excessive reduction in a luminance can be prevented.

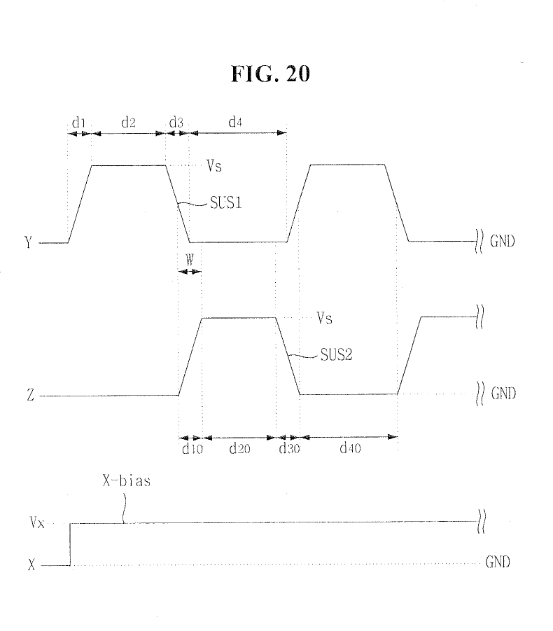

FIG. 20 is a diagram for explaining the overlap of sustain signals.

As illustrated in FIG. 20, a first sustain signal SUS1 and a second sustain signal SUS2 are alternately supplied to the scan electrode Y and the sustain electrode Z. The first sustain signal SUS1 and the second sustain signal SUS2 may overlap each other.

The first sustain signal SUS1 includes a voltage rising period d1, a first voltage maintenance period d2 during which the first sustain signal SUS1 is maintained at a highest voltage Vs, a voltage falling period d3, and a second voltage maintenance period d4 during which the first sustain signal SUS1 is maintained at a lowest voltage GND. The second sustain signal SUS2 includes a voltage rising period d10, a first voltage maintenance period d20 during which the second sustain signal SUS2 is maintained at a highest voltage Vs, a voltage falling period d30, and a second voltage maintenance period d40 during which the second sustain signal SUS2 is maintained at a lowest voltage GND. The voltage falling period d3 of the first sustain signal SUS1 may overlap the voltage rising period d10 of the second sustain signal SUS2.

When two successively applied sustain signals overlap each other, the number of sustain signals capable of being applied during a sustain period can increase. Hence, a luminance can be improved. Further, when the phosphor layer or the upper dielectric layer includes a pigment, the overlap of the sustain signals can compensate for a reduction in a luminance caused by the pigment.

An address bias signal X-Bias, which is maintained at a voltage Vx higher than the ground level voltage GND, is supplied to the address electrode X during the sustain period. Hence, a voltage difference between the scan electrode Y and the address electrode X and a voltage difference between the sustain electrode Z and the address electrode X can be reduced during the sustain period. Furthermore, a sustain discharge between the scan electrode Y and the sustain electrode Z can occur close to the front substrate. The efficiency of the sustain discharge can be improved and a degradation of the phosphor layer can be suppressed.

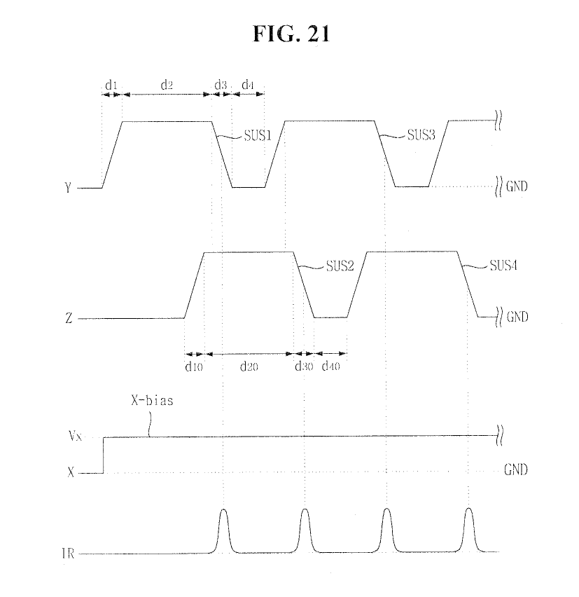

FIG. 21 is a diagram for explaining a first maintenance period and a second maintenance period.

As illustrated in FIG. 21, the voltage falling period d3 of the first sustain signal SUS1 may overlap the first voltage maintenance period d20 of the second sustain signal SUS2.

A sustain discharge may occur due to an increase in a voltage difference between the scan electrode and the sustain electrode during the voltage falling periods d3 and d30 of the first and second sustain signals SUS1 and SUS2.

Further, a sustain discharge may occur due to an increase in a voltage difference between the scan electrode and the sustain electrode during the voltage rising periods d1 and d10 of the first and second sustain signals SUS1 and SUS2. In this case, a self-erase discharge may frequently occur due to electrons moving from the phosphor layer in a direction toward the scan electrode or the sustain electrode, and thus wall charges accumulated on the scan electrode or the sustain electrode may be erased. Hence, the sustain discharge may unstably occur due to the insufficient amount of wall charges. The self-erase discharge may more frequently occur due to an increase in an interference of the phosphor layer when an interval between the scan electrode and the sustain electrode is relatively wide, for instance, when an interval between the scan electrode and the sustain electrode is larger than a height of the barrier rib.

On the contrary, when a sustain discharge occurs due to an increase in the voltage difference between the scan electrode and the sustain electrode during the voltage falling periods d3 and d30, the sustain discharge occurs due to electrons moving from the scan electrode or the sustain electrode to a direction toward the phosphor layer. Hence, a self-erase discharge can be suppressed. The generation of the self-erase discharge can be suppressed although the interval between the scan electrode and the sustain electrode is larger than the height of the barrier rib.

As above, a time width of each of the first voltage maintenance periods d2 and d20 may be longer than a time width of each of the second voltage maintenance periods d4 and d40 so as to increase the voltage difference between the scan electrode and the sustain electrode during the voltage falling periods d3 and d30. Hence, the voltage falling period d3 can overlap the first voltage maintenance period d20, and thus sustain discharge can occur during the voltage falling period d3. Further, the self-erase discharge can be suppressed.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A plasma display panel comprising:
a front substrate on which a scan electrode and a sustain electrode are positioned parallel to each other, the scan electrode and the sustain electrode each having a single-layered structure;
an upper dielectric layer positioned on the scan electrode and the sustain electrode;
a rear substrate on which an address electrode is positioned to intersect the scan electrode and the sustain electrode;
a lower dielectric layer positioned on the address electrode;
a barrier rib that is positioned between the front substrate and the rear substrate and partitions a discharge cell; and
a phosphor layer that is positioned inside the discharge cell and includes YVPO₄:Eu.

2. The plasma display panel of claim 1, wherein the scan electrode and the sustain electrode each include a plurality of line portions intersecting the address electrode, at least one connection portion connecting at least two line portions of the plurality of line portions, and at least one projecting portion projecting from the plurality of line portions.

3. The plasma display panel of claim 1, wherein the phosphor layer includes a first phosphor layer emitting red light, a second phosphor layer emitting blue light, and a third phosphor layer emitting green light, and
the first phosphor layer includes YVPO₄:Eu.

4. The plasma display panel of claim 3, wherein the first phosphor layer includes an iron (Fe)-based material as a red pigment.

5. The plasma display panel of claim 3, wherein the second phosphor layer includes a phosphor material and a blue pigment, and
the blue pigment includes at least one of a cobalt (Co)-based material, a copper (Cu)-based material, a chrome (Cr)-based material, a nickel (Ni)-based material, an aluminum (Al)-based material, a titanium (Ti)-based material or a neodymium (Nd)-based material.

6. The plasma display panel of claim 1, wherein the upper dielectric layer includes a glass-based material and a pigment, and
the pigment includes at least one of a cobalt (Co)-based material, a copper (Cu)-based material, a chrome (Cr)-based material, a nickel (Ni)-based material, an aluminum (Al)-based material, a titanium (Ti)-based material, a cerium (Ce)-based material, a manganese (Mn)-based material or a neodymium (Nd)-based material.

7. The plasma display panel of claim 6, wherein a content of pigment included in the upper dielectric layer ranges from 0.1 to 0.6 part by weight.

8. A plasma display panel comprising:
a front substrate on which a scan electrode and a sustain electrode are positioned parallel to each other, the scan electrode and the sustain electrode each having a single-layered structure;
an upper dielectric layer positioned on the scan electrode and the sustain electrode, the upper dielectric layer including lead (Pb) equal to or less than 1,000 ppm (parts per million);
a rear substrate on which an address electrode is positioned to intersect the scan electrode and the sustain electrode;
a lower dielectric layer positioned on the address electrode;
a barrier rib that is positioned between the front substrate and the rear substrate and partitions a discharge cell; and
a phosphor layer that is positioned inside the discharge cell and includes YVPO₄:Eu.

9. The plasma display panel of claim 8, wherein the scan electrode and the sustain electrode each include a plurality of line portions intersecting the address electrode, at least one connection portion connecting at least two line portions of the plurality of line portions, and at least one projecting portion projecting from the plurality of line portions.

10. The plasma display panel of claim 8, wherein the phosphor layer includes a first phosphor layer emitting red light, a second phosphor layer emitting blue light, and a third phosphor layer emitting green light, and
the first phosphor layer includes YVPO₄:Eu.

11. The plasma display panel of claim 10, wherein the first phosphor layer includes an iron (Fe)-based material as a red pigment.

12. The plasma display panel of claim 10, wherein the second phosphor layer includes a phosphor material and a blue pigment, and
the blue pigment includes at least one of a cobalt (Co)-based material, a copper (Cu)-based material, a chrome (Cr)-based material, a nickel (Ni)-based material, an aluminum (Al)-based material, a titanium (Ti)-based material or a neodymium (Nd)-based material.

13. The plasma display panel of claim 8, wherein the upper dielectric layer includes a glass-based material and a pigment, and
the pigment includes at least one of a cobalt (Co)-based material, a copper (Cu)-based material, a chrome (Cr)-based material, a nickel (Ni)-based material, an aluminum (Al)-based material, a titanium (Ti)-based material, a cerium (Ce)-based material, a manganese (Mn)-based material or a neodymium (Nd)-based material.

14. The plasma display panel of claim 13, wherein a content of pigment included in the upper dielectric layer ranges from 0.1 to 0.6 part by weight.

15. A plasma display apparatus comprising:
a front substrate on which a scan electrode and a sustain electrode are positioned parallel to each other;
an upper dielectric layer positioned on the scan electrode and the sustain electrode, the upper dielectric layer including a glass-based material and a first blue pigment;
a rear substrate on which an address electrode is positioned to intersect the scan electrode and the sustain electrode;
a lower dielectric layer positioned on the address electrode;
a barrier rib that is positioned between the front substrate and the rear substrate and partitions a discharge cell; and
a phosphor layer positioned inside the discharge, the phosphor layer including a first phosphor layer emitting red light, a second phosphor layer emitting blue light, and a third phosphor layer emitting green light, the first phosphor layer including a red pigment,
wherein a first sustain signal is supplied to the scan electrode and a second sustain signal overlapping the first sustain signal is supplied to the sustain electrode during a sustain period of at least one subfield of a frame.

16. The plasma display apparatus of claim 15, wherein the first sustain signal and the second sustain signal each include a voltage rising period, a first voltage maintenance period during which the first and second sustain signals are maintained at a highest voltage, a voltage falling period, and a second voltage maintenance period during which the first and second sustain signals are maintained at a lowest voltage, and
the voltage falling period of the first sustain signal overlaps the voltage rising period of the second sustain signal.

17. The plasma display apparatus of claim 15, wherein the first sustain signal and the second sustain signal each include a voltage rising period, a first voltage maintenance period during which the first and second sustain signals are maintained at a highest voltage, a voltage falling period, and a second voltage maintenance period during which the first and second sustain signals are maintained at a lowest voltage, and
a voltage difference between the scan electrode and the sustain electrode increases during the voltage falling periods of the first and second sustain signals,

18. The plasma display apparatus of claim 15, wherein the first sustain signal and the second sustain signal each include a voltage rising period, a first voltage maintenance period during which the first and second sustain signals are maintained at a highest voltage, a voltage falling period, and a second voltage maintenance period during which the first and second sustain signals are maintained at a lowest voltage, arid
a time width of the first voltage maintenance period of each of the first and second sustain signals is longer than a time width of the second voltage maintenance period of each of the first and second sustain signals.

19. The plasma display apparatus of claim 15, wherein an address bias signal maintained at a voltage level higher than a ground level voltage is supplied to the address electrode during the sustain period.
